(19) United States
(12) Patent Application Publication
(10) Pub. No.: US 2023/0105702 A1
(43) Pub. Date: Apr. 6, 2023

(54) SPLINE WRENCH

(71) Applicant: JAMES CLARY, Dekalb, TX (US)

(72) Inventor: JAMES CLARY, Dekalb, TX (US)

(21) Appl. No.: 17/495,530

(22) Filed: Oct. 6, 2021

(51) Int. Cl. B25B 13/50

(52) U.S. Cl. CPC B25B 13/5033

(57) ABSTRACT

A Spline Wrench is disclosed for manually rotating clockwise and engaging a power take off (“PTO”) drive shaft of a tractor, truck, aircraft, or watercraft having six or more splines for aligning the PTO with a female coupling of a machine, tool, or equipment, such as a mower, tiller, combine, water pump, air pump, fuel pump, compressor, generator, or other similar machine, tool, or equipment. The apparatus is used to rotate clockwise and align the splines of a spline shaft manually without having to engage the engine and transmission and pulsing the shaft to rotate it into position. Various embodiments of the Spline Wrench are designed to engage the splines of a Type 1 540 RPM 1 3/8 in. diameter 6-spline shaft, a Type 2 1000 RPM 1 3/8 in. diameter 21-spline shaft, a Type 3 1000 RPM 1 3/4 in. diameter 20-spline shaft, and a Type 4 1300 RPM 2 1/4 in. diameter 22-spline shaft.

### FIELD OF THE INVENTION

The present invention relates generally to hand-held tools. More particularly, the present invention is directed to a hand-held adjustable spline wrench for rotating a power take-off or power takeoff (“PTO”) shaft for connecting the shaft to an equipment, tool, or machine.

### BACKGROUND OF THE INVENTION

A PTO is any of several methods for taking power from a power source, such as a running engine, and transmitting it to a separately attached equipment, tool, or machine. Most commonly, it is a splined drive shaft that is installed on a tractor or truck allowing equipment or machines with complimentary fittings to be powered directly by the tractor or truck engine. Semi-permanently mounted PTOs can also be found on industrial and marine engines. These engines typically use a drive shaft and bolted joint to transmit power to a secondary device attached to the PTO shaft. In the case of agricultural applications, the attached equipment or machines may be, for example, combines, mowers, plows, fertilizer spreaders, seeders, balers, sprayers, transplanters, and cultivators. In the case of marine or boat applications, the attached equipment or machines may be, for example, water, hydraulic, or fuel pumps. In aircraft applications, the attached equipment or machines may be, for example, accessories for putting power into the engine during engine startup.

The original PTO type, designated as “Type 1,” calls for operation at 540 revolutions per minute (“rpm”). A shaft that rotates at 540 rpm has 6 splines on it and a diameter of 1 ⅜ in. or approximately 35 mm. Two newer PTO types, supporting higher power applications, operate at 1000 rpm and differ in shaft size. The larger shaft, designated as “Type 3,” has 20 splines with a diameter of 1 ¾ in. or approximately 44 mm, while the smaller type, designated as “Type 2,” has 21 splines with a diameter of 1 ⅜ in or approximately 35 mm. Farmers typically differentiate these two types by calling them “large 1000” or “small 1000” as compared to the Type 1, which is commonly referred to as the “540.”

Due to ever-increasing horsepower requirements from farm equipment, tools, and machines, and higher horsepower engines being installed in farm tractors, a still larger PTO type, designated as “Type 4,” has been added. It operates at a higher rotational speed of 1300 rpm in order to allow for power transfer at reduced levels of torque. The shaft has 22 splines with a major diameter of 2 ¼ in. or approximately 57.5 mm. It is meant to handle PTO powers up to 450 kW, or roughly 600 hp. All four PTO types rotate clockwise.

To connect the PTO shaft to another device, the shaft must be rotated so that its splines are aligned with the splines or coupling of the equipment, tool, or machine to which it is to be connected. It is typically difficult, if not impossible, to turn the PTO shaft of many tractors, trucks, boats, and aircraft by hand. The PTO shaft normally is driven by the transmission and is turned or pulsed when the engine and transmission are engaged. A need exists for a tool that manually engages the PTO shaft and rotates it clockwise with the transmission is set in neutral.

European Patent No. EP0166675B1, issued on Jan. 17, 1990, to Hamilton discloses a wrench for making and breaking connections between tubular members in the oil and gas industry. The wrench has a frame and a gate arm having latching teeth that is pivotally secured to the frame and pivotable between an open position and a closed position. The wrench also has a latch arm that is pivotally secured to the frame and pivotable between an open position and a closed position, characterized by latching teeth provided along the interior surface for engagement with the latching teeth of the gate arm. The Hamilton wrench would not work well with the Type 1, 2, 3, or 4 splines because it does not have teeth that are spaced to fit specifically in the grooves of a spline shaft. It also cannot be quickly and easily attached and removed without having to slide the wrench over the end of the spline shaft.

U.S. Patent Application Publication No. 2002/0039523, published on Apr. 4, 2002, to Hartmann discloses a fastener, such as a screw, including a head and an inner polygon having a design corresponding to a spline shaft that is formed by a plurality of tangential surfaces. While the fastener would fit over a six spline shaft, it is too small to fit over the Type 1 spline shaft of tractors, trucks, aircraft, and marine spline shafts. The Hartmann fastener also is not designed to fit over Type 2, 3, and 4 spline shafts.

U.S. Pat. No. 9,009,943, issued on Apr. 21, 2015, to Noel discloses a U-shaped wrench having a screw inserted through one of the U sides of the wrench. Once the screw is loosened, the U portion of the wrench is dimensioned to slide over the width of the PTO shaft. Once over the shaft, the screw is tightened until it engages tightly in a groove between two splines. Using the handle of the wrench, a user may then rotate the PTO shaft clockwise until the male splines of the shaft align with the female splines or coupling of the equipment or machine to be attached. The PTO shaft may then be connected with the equipment, tool, or machine. The Noel wrench may be too large or small for the type of PTO shaft that needs rotating. Nor can it be quickly and easily attached, removed, or repositioned. It must first be screwed or unscrewed from the shaft before it can be attached, removed, or repositioned.

### SUMMARY OF THE INVENTION

It is an object of this invention to overcome the disadvantages of the prior art and create wrench devices that are capable of engaging the splines of PTO shaft Types 1, 2, 3, and 4 of a tractor, truck, boat, or aircraft having from 6 to 22 splines.

A further object of the invention is to create a wrench device for manually rotating a PTO shaft of a tractor, truck, boat, or aircraft to align and connect or couple the shaft with a female PTO shaft or coupling of an equipment, tool, or machine.

A Type 1 Spline Wrench according to the invention includes a wrench having a handle and a head with three equally sized teeth and four equally sized grooves for removably engaging a Type 1 540 RPM 1 ⅜ in. diameter 6-spline shaft.

A Type 2 Spline Wrench according to the invention includes a wrench having a handle and a head with eleven equally sized teeth and twelve equally sized grooves for removably engaging a Type 2 1000 RPM 1 ⅜ in. diameter 21-spline shaft.

A Type 3 Spline Wrench according to the invention includes a wrench having a handle and a head with ten equally sized teeth and eleven equally sized grooves for removably engaging a Type 3 1000 RPM 1 ¾ in. diameter 20-spline shaft.

A Type 4 Spline Wrench according to the invention includes a wrench having a handle and a head with eleven equally sized teeth and twelve equally sized grooves for removably engaging a Type 4 1300 RPM 2 ¼ in. diameter 20-spline shaft.

Once engaged with the Type 1, 2, 3, or 4 Spline Wrench, the PTO shaft may be manually rotated clockwise by grasping and urging the handle, which extends in a radial direction from the PTO shaft, in a direction about the rotational axis of the PTO shaft without having to pulse the shaft with the engine and transmission until it aligns with a corresponding female-fitted spline or coupling. Once engaged with the female-fitted spline or coupling, the PTO shaft may drive the attached equipment, tool, or machine.

### BRIEF DESCRIPTION OF THE DRAWINGS

Further details of the invention are described in the written specification below and in the drawings in which:

FIG. 1 is an illustrative view of a Type 1 Spline Wrench for removably engaging a Type 1 540 RPM 1 ⅜ in. diameter 6-spline shaft;

FIG. 2 is an illustrative view of a Type 2 Spline Wrench for removably engaging a Type 2 1000 RPM 1 ⅜ in. diameter 21-spline shaft;

FIG. 3 is an illustrative view of a Type 3 Spline Wrench for removably engaging a Type 3 1000 RPM 1 ¾ in. diameter 20-spline shaft;

FIG. 4 is an illustrative view of a Type 4 Spline Wrench for removably engaging a Type 4 1300 RPM 2 ¼ in. diameter 22-spline shaft;

FIG. 5 is an illustrative view of a Type 1 Spline Wrench engaging and rotating in a clockwise direction a Type 1 540 RPM 1 ⅜ in. diameter 6-spline shaft;

FIG. 6 is an illustrative view of a Type 2 Spline Wrench engaging and rotating in a clockwise direction a Type 2 1000 RPM 1 ⅜ in. diameter 21-spline shaft;

FIG. 7 is an illustrative view of a Type 3 Spline Wrench engaging and rotating in a clockwise direction a Type 3 1000 RPM 1 ¾ in. diameter 20-spline shaft; and

FIG. 8 is an illustrative view of a Type 4 Spline Wrench engaging and rotating in a clockwise direction a Type 4 1300 RPM 2 ¼ in. diameter 22-spline shaft.

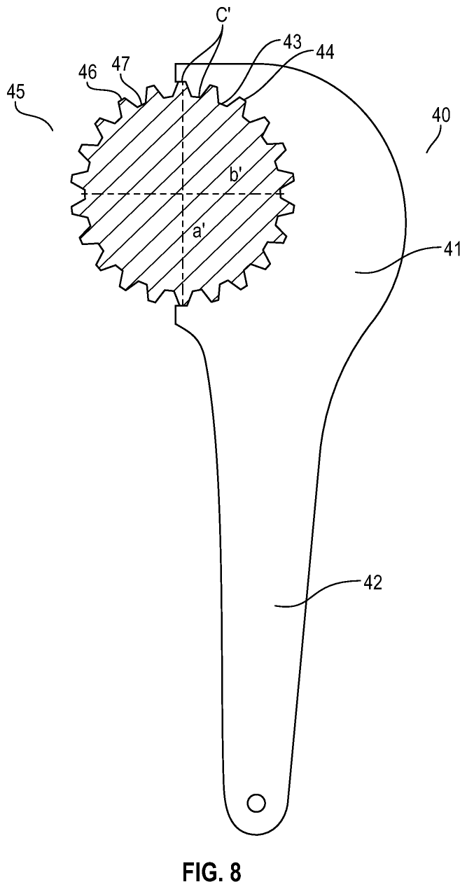

### DETAILED DESCRIPTION OF THE EMBODIMENTS

The following described embodiments are just some examples of how this invention may be implemented and are not intended to limit the scope of the invention in any way.

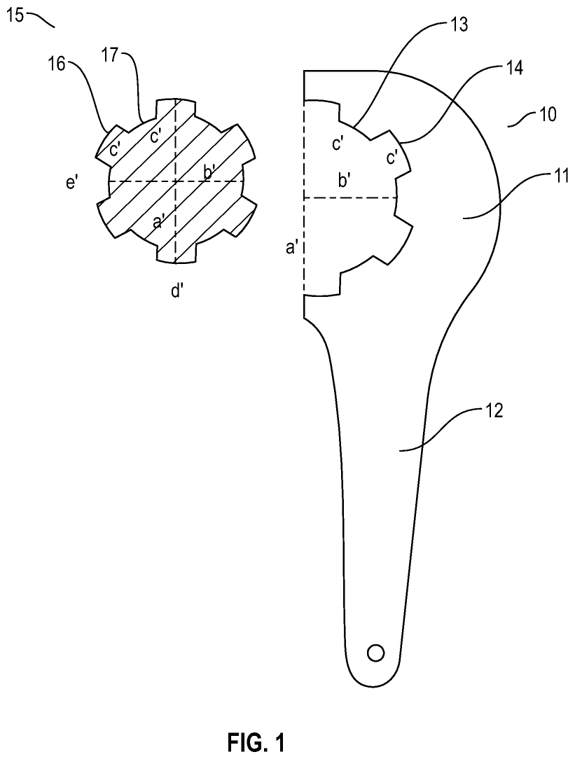

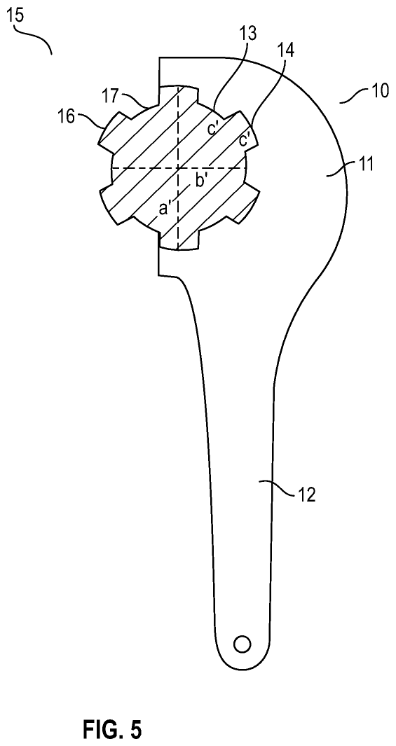

FIG. 1 illustrates an embodiment of the invention as a Type 1 Spline Wrench (10) for removably engaging a Type 1 540 RPM 1 ⅜ in. diameter 6-spline shaft (15). The Spline Wrench (10) may be made of metal, plastic, wood, or any similar material. The Spline Wrench (10) has a head portion (11), a handle (12), teeth (13), and grooves (14). The Type 1 spline shaft (15) has teeth (16) and grooves (17) of equal width (c′), which as shown is approximately between 8.59 and 8.64 mm. Shaft (15) has an outer diameter (d′) of approximately 1 ⅜ inches or approximately between 34.87 and 34.82 mm and a radius (a′), which is approximately half the length of the outer diameter. Shaft (15) has an inner diameter (e′) of approximately between 28.14 and 27.99 mm and a radius (b′), which is approximately half the length of the inner diameter (e′). Teeth (13) and grooves (14) of the Spline Wrench (10) have the same width (c′) as the teeth (16) and grooves (17) of the spine shaft (15) for removably engaging the Spline Wrench (10) on spline shaft (15). The inner dimensions of the Spline Wrench (10) also have the same radii (a′, b′) as the spline shaft (15) to ensure a proper engagement between the Spline Wrench (10) and spine shaft (15). Once the head portion (11) of the Spline Wrench (10) and spline shaft (15) are removably engaged as shown in FIG. 5, a user may use the handle (12) to rotate the spline shaft (15) clockwise until the shaft aligns with the female coupling of the equipment, tool, or machine to be connected.

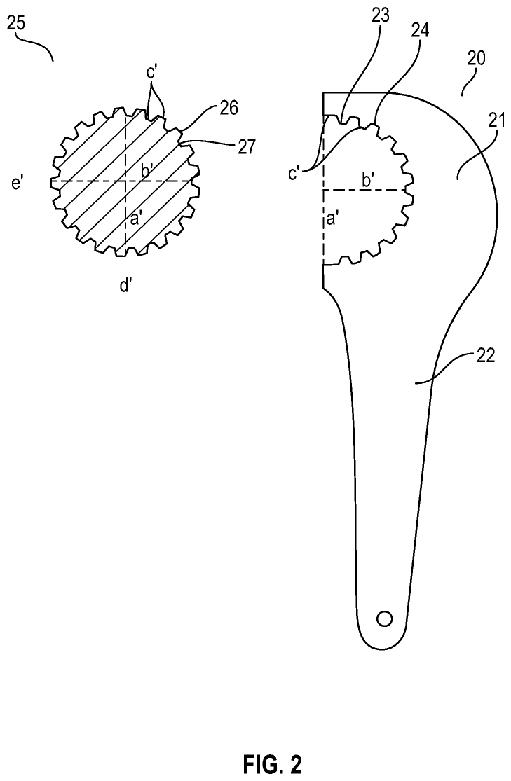

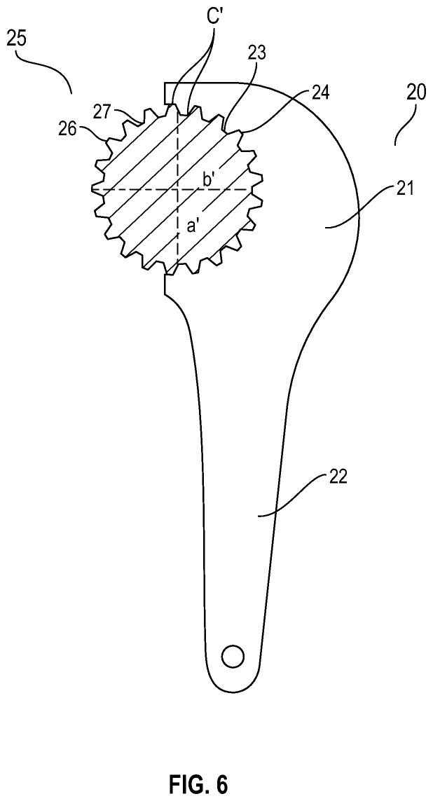

FIG. 2 illustrates an embodiment of the invention as a Type 2 Spline Wrench (20) for removably engaging a Type 2 1000 RPM 1 ⅜ in. diameter 21-spline shaft (25). The Spline Wrench (20) may be made of metal, plastic, wood, or any similar material. The Spline Wrench (20) has a head portion (21), a handle (22), teeth (23), and grooves (24). The Type 2 spline shaft (25) has teeth (26) and grooves (27) of equal width (c′), which as shown is approximately between 2.47 and 2.48 mm. Shaft (25) has an outer diameter (d′) of approximately 1 ⅜ inches or approximately between 34.85 and 34.88 mm and a radius (a′), which is approximately half the length of the outer diameter. Shaft (25) has an inner diameter (e′) of approximately 31.30 mm and a radius (b′), which is approximately half the length of the inner diameter (e′). Teeth (23) and grooves (24) of the Spline Wrench (20) have the same width (c′) as the teeth (26) and grooves (27) of the spine shaft (25) for removably engaging the Spline Wrench (20) on spline shaft (25). The inner dimensions of the Spline Wrench (20) also have the same radii (a′, b′) as the spline shaft (25) to ensure a proper engagement between the Spline Wrench (20) and spine shaft (25). Once the head portion (21) of the Spline Wrench (20) and spline shaft (25) are removably engaged as shown in FIG. 6, a user may use the handle (22) to rotate the spline shaft (25) clockwise until the shaft aligns with the female coupling of the equipment, tool, or machine to be connected.

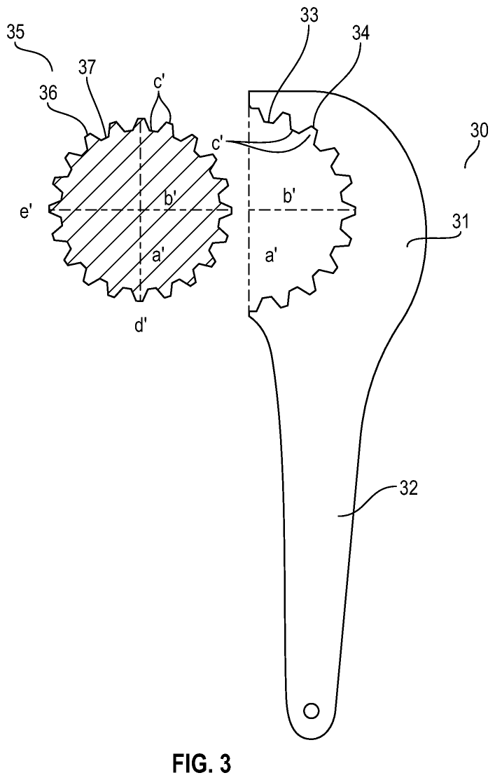

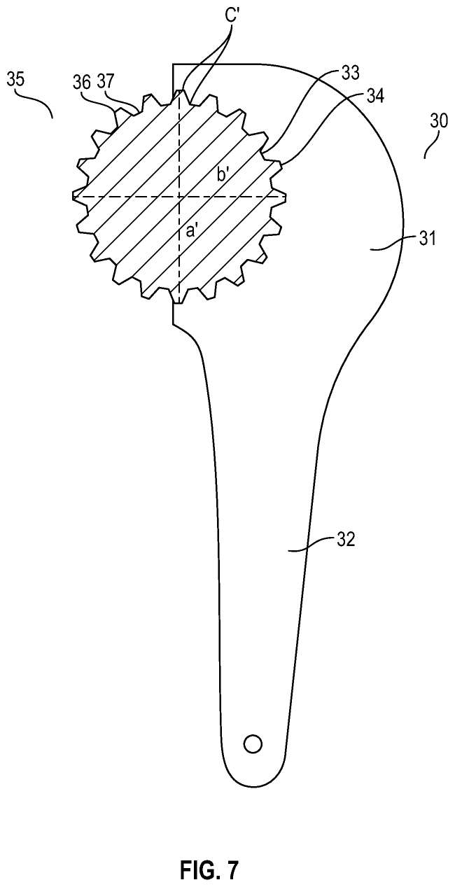

FIG. 3 illustrates an embodiment of the invention as a Type 3 Spline Wrench (30) for removably engaging a Type 3 1000 RPM 1 ¾ in. diameter 20-spline shaft (35). The Spline Wrench (30) may be made of metal, plastic, wood, or any similar material. The Spline Wrench (30) has a head portion (31), a handle (32), teeth (33), and grooves (34). The Type 3 spline shaft (35) has teeth (36) and grooves (37) of equal width (c′), which as shown is approximately between 3.29 and 3.30 mm. Shaft (35) has an outer diameter (d′) of approximately 1 ⅜ inches or approximately between 44.12 and 44.27 mm and a radius (a′), which is approximately half the length of the outer diameter. Shaft (35) has an inner diameter (e′) of approximately 39.21 mm and a radius (b′), which is approximately half the length of the inner diameter (e′). Teeth (33) and grooves (34) of the Spline Wrench (30) have the same width (c′) as the teeth (36) and grooves (37) of the spine shaft (35) for removably engaging the Spline Wrench (30) on spline shaft (35). The inner dimensions of the Spline Wrench (20) also have the same radii (a′, b′) as the spline shaft (35) to ensure a proper engagement between the Spline Wrench (30) and spine shaft (35). Once the head portion (31) of the Spline Wrench (30) and spline shaft (35) are removably engaged as shown in FIG. 7, a user may use the handle (32) to rotate the spline shaft (35) clockwise until the shaft aligns with the female coupling of the equipment, tool, or machine to be connected.

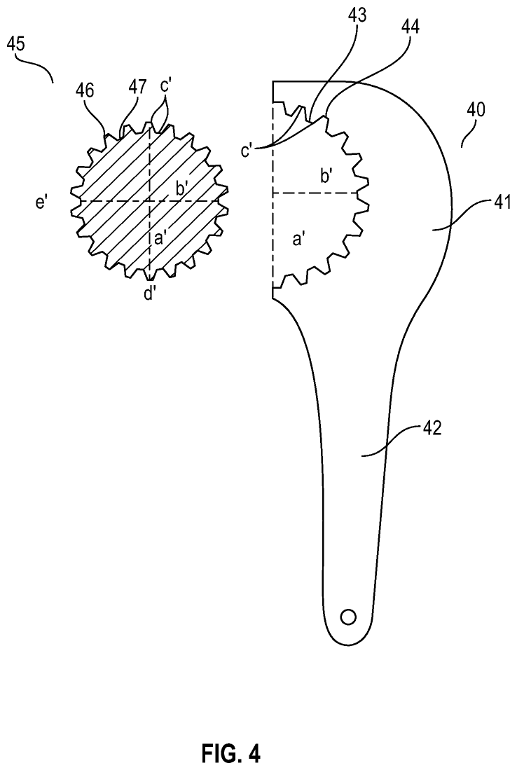

FIG. 4 illustrates an embodiment of the invention as a Type 4 Spline Wrench (40) for removably engaging a Type 4 1300 RPM 2 ¼ in. diameter 20-spline shaft (45). The Spline Wrench (40) may be made of metal, plastic, wood, or any similar material. The Spline Wrench (40) has a head portion (41), a handle (42), teeth (43), and grooves (44). The Type 2 spline shaft (45) has teeth (46) and grooves (47) of equal width (c′), which as shown is approximately between 4.28 and 4.29 mm. Shaft (45) has an outer diameter (d′) of approximately 2 ¼ inches or approximately between 57.475 and 57.500 mm and a radius (a′), which is approximately half the length of the outer diameter. Shaft (45) has an inner diameter (e′) of approximately between 50.93 and 51.18 mm and a radius (b′), which is approximately half the length of the inner diameter (e′). Teeth (43) and grooves (44) of the Spline Wrench (40) have the same width (c′) as the teeth (46) and grooves (47) of the spine shaft (45) for removably engaging the Spline Wrench (40) on spline shaft (45). The inner dimensions of the Spline Wrench (40) also have the same radii (a′, b′) as the spline shaft (45) to ensure a proper engagement between the Spline Wrench (40) and spine shaft (45). Once the head portion (41) of the Spline Wrench (40) and spline shaft (45) are removably engaged as shown in FIG. 7, a user may use the handle (42) to rotate the spline shaft (45) clockwise until the shaft aligns with the female coupling of the equipment, tool, or machine to be connected.

The matter set forth in the foregoing description and drawings is offered by way of illustration only and not as a limitation. While particular embodiments have been shown and described, it will be apparent to those skilled in the art that changes and modifications may be made without departing from the broader aspects of the inventor's contribution. The actual scope of the protection sought is intended to be defined in the following claims when viewed in their proper perspective based on the prior art.

I claim:

1. An apparatus, comprising:
a handle;
a head portion having two or more teeth for engaging the splines and grooves of a power take off shaft, the teeth and grooves of the apparatus having nearly equal widths as the teeth and grooves of the power take off shaft so that the teeth of the apparatus fit snugly in the grooves of the power take off shaft; and
the handle and two or more teeth capable of rotating the power take off shaft in a clockwise direction by a user.

2. The apparatus of claim 1 further comprising the teeth and grooves capable of engaging and rotating a 540 RPM 1 ⅜ in. diameter 6-spline shaft.

3. The apparatus of claim 1 further comprising the teeth and grooves capable of engaging and rotating a 1000 RPM 1 ⅜ in. diameter 21-spline shaft.

4. The apparatus of claim 1 further comprising the teeth and grooves capable of engaging and rotating a 1000 RPM 1 ¾ in. diameter 20-spline shaft.

5. The apparatus of claim 1 further comprising the teeth and grooves capable of engaging and rotating a 1300 RPM 2 ¼ in. diameter 22-spline shaft.

6. The apparatus of claim 1 further comprising the teeth and grooves capable of engaging a power take off shaft having six or more splines.

7. The apparatus of claim 1 further comprising the apparatus being made of plastic.

8. The apparatus of claim 1 further comprising the apparatus being made of metal.

9. The apparatus of claim 1 further comprising the apparatus being made of wood.
